(19) United States
(12) Patent Application Publication
(10) Pub. No.: US 2003/0183740 A1
(43) Pub. Date: Oct. 2, 2003

(54) Breakaway sign-stand

(75) Inventors: Michael Knapp, Elmira, NY (US); Dominic Howe, Horseheads, NY (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Eastern Metal of Elmira, Inc.

(21) Appl. No.: 10/112,130

(22) Filed: Mar. 29, 2002

(51) Int. Cl. F16M 13/00

(52) U.S. Cl. 248/548; 248/160; 248/909

(57) ABSTRACT

A breakaway member for a sign-stand having a two piece mast that supports a sign includes a first end that connects to a first mast piece which is secured to the sign, a second end that connects to a second mast piece, and a breakaway section that fractures therethrough upon impact thereby carrying the first end, the first mast piece and the sign away from the second mast piece. In a preferred embodiment, the breakaway member has a generally I-beam shaped cross-section. The first and second mast pieces have a generally rectangular and hollow cross-section. The first end of the breakaway member is disposed in the first mast piece, the second end of the breakaway member is disposed in the second mast piece, and the breakaway section is located between the first and second mast pieces.

### BACKGROUND OF THE INVENTION

The present invention relates generally to sign and sign-stand devices for signs and display devices of all kinds. The invention more particularly relates to a breakaway sign-stand for safety purposes and supporting signs, particularly temporary road signs, that may be struck by motor vehicles around construction sites or roadways.

There are numerous sign-stands and poster display devices known today which are used for displaying various signs and messages for advertisement and to convey information to the public. On construction sites, the signs are typically positioned on posts or sign-stands which are either anchored in the ground, held in place by sandbags or other heavy objects, or are spring-mounted on bases which allow them to bend without tipping over under high wind forces. Spring mounted sign-stands which can be used for this purpose are shown in U.S. Pat. Nos. 3,646,696; 3,662,082; 4,033,536; 4,265,040; 4,288,053; and 4,509,714, the subject matter of which are incorporated herein by reference.

Signs commonly used at construction sites are square, rectangular, or diamond in shape, flat in configuration, made of metal, wood, plastic, or flexible fabric, and have pertinent information or warning messages or symbols on them. Although flexible, roll-up type signs are being used more frequently today, wood, metal and plastic signs, which may be heavy, are still very common.

Many of the signs found on construction sites are placed in temporary locations that are not necessarily off the roadway, which subjects them to potential impacts from automobiles and other roadway traffic. Many portable sign-stands are designed so that they may flex in high winds but not tip over, and are constructed using lightweight, primarily rigid materials, making them easy to transport, yet substantial enough to resist the force of high winds. A common problem with this type of design is that when struck by a vehicle, the stand will not break clean through, in a predictable enough manner to predetermine where, and with what force, the sign or sign-stand will make contact with the impact vehicle. This is especially problematic with wood, metal, and some plastic signs that are heavier and more rigid and can cause substantial damage when struck.

What is a needed is a sign-stand that breaks clean through upon impact and allows the sign and uppermost portion of the sign-stand to move out of the direct path of the vehicle thereby minimizing or eliminating danger to the occupants and damage to the vehicle. The sign-stand must still be strong enough to handle normal static load and wind load (together being the live load) without fracturing or deforming, yet the sign-stand should be brittle or “weak enough”, in terms of its material properties, at a location along its vertical mast or post, such that a lateral impact force causes it to fracture clean through and/or shear completely off near the base.

### BRIEF SUMMARY OF THE INVENTION

Briefly stated, the present invention comprises a breakaway member for a sign-stand having a two piece mast that supports a sign. The breakaway member includes a first end that connects to a first mast piece which is secured to the sign, a second end that connects to a second mast piece, and a breakaway section that fractures therethrough upon impact thereby carrying the first end, the first mast piece and the sign away from the second mast piece.

In a preferred embodiment, the breakaway member has a generally I-beam shaped cross-section. The first and second mast pieces have a generally rectangular or square and hollow cross-section. The first end of the breakaway member is disposed in the first mast piece, the second end of the breakaway member is disposed in the second mast piece, and the breakaway section is located between the first and second mast pieces.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a front elevational view of a typical construction-type sign with a breakaway member in accordance with a first preferred embodiment of the present invention;

FIG. 2 is an enlarged exploded view of portions of the sign of FIG. 1;

FIG. 3A is an enlarged top plan view of the breakaway member of FIG. 1;

FIG. 3B is a front elevational view of the breakaway member shown in FIG. 3A;

FIG. 3C is a side elevational view of the breakaway member shown in FIG. 3A;

FIG. 3D is a perspective view of the breakaway member shown in FIG. 3A;

FIG. 4 is a perspective view of the breakaway member of the present invention installed in a receiver portion of a mast;

FIG. 5 is a perspective view of the breakaway member and receiver of FIG. 4 with a pole partially installed;

FIG. 6 is an enlarged exploded view of a breakaway member in accordance with a second preferred embodiment of the present invention and the receiver and pole;

FIG. 7A is an enlarged top view of the breakaway member of FIG. 6;

FIG. 7B is a front elevational view of the breakaway member shown in FIG. 7A;

FIG. 7C is a side elevational view of the breakaway member shown in FIG. 7A;

FIG. 7D is a perspective view of the breakaway member shown in FIG. 7A;

FIG. 8 is an enlarged exploded view of a breakaway member in accordance with a first alternate embodiment of the present invention and the receiver and pole; and

FIG. 9 is an enlarged exploded view of a breakaway member in accordance with a second alternate embodiment of the present invention and the receiver and pole.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from respectively, the geometric center of the sign mast and designated parts thereof. The terminology includes the words above specifically mentioned, derivatives thereof and words of similar import. Additionally, the word “a” used in the specification, means “at least one.”

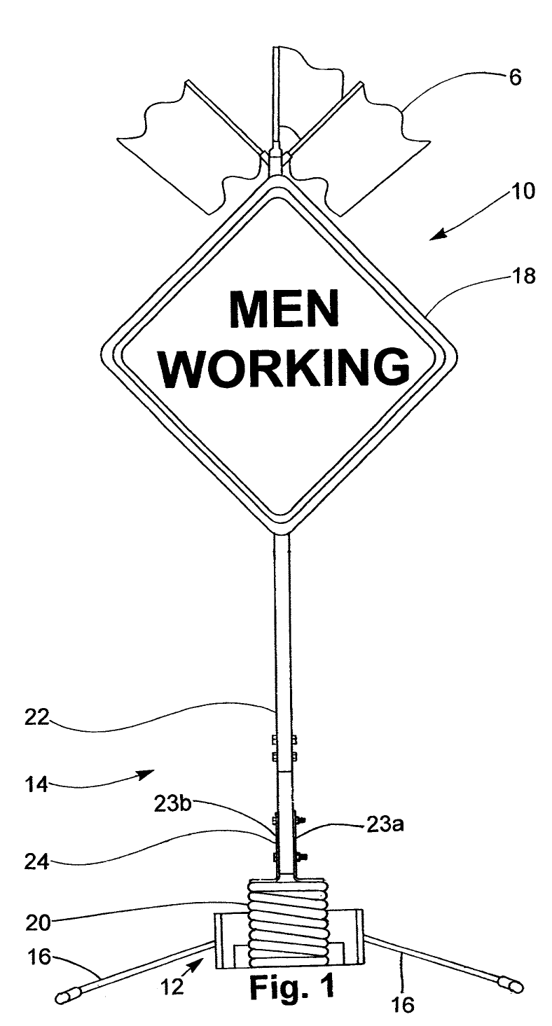

FIG. 1 is a front elevational view of a construction sign assembly 10 that incorporates a first preferred embodiment of the present invention. The construction sign assembly 10 is mounted on an upright stand or sign mast 14. The sign mast 14 is supported on the ground by a plurality of legs 16, a base 12, and a resilient member 20. The resilient member 20 allows the sign assembly 10 and sign mast 14 to deflect downwardly when subjected to wind forces and then return to its normal upright position as shown in FIG. 1. The resilient member 20 is typically one or more coil springs or leaf-springs, but the precise resilient members used are not critical to the present invention. Spring-mounted sign-stands which can be used for this purpose are disclosed in U.S. Pat. Nos. 3,646,696; 3,662,082; 4,033,536; 4,265,040; 4,288,053; and 4,509,714. It is understood, of course, that the present breakaway sign-stand can be used with any type of sign-stand or pole, whether permanently anchored or portable, and whether spring-mounted or rigidly-mounted.

At the top of the sign mast 14 may be a plurality of warning flags 6 held in place by a bracket (not shown). As is commonly known in the construction industry, the flags 6 are used as a high level warning for approaching traffic.

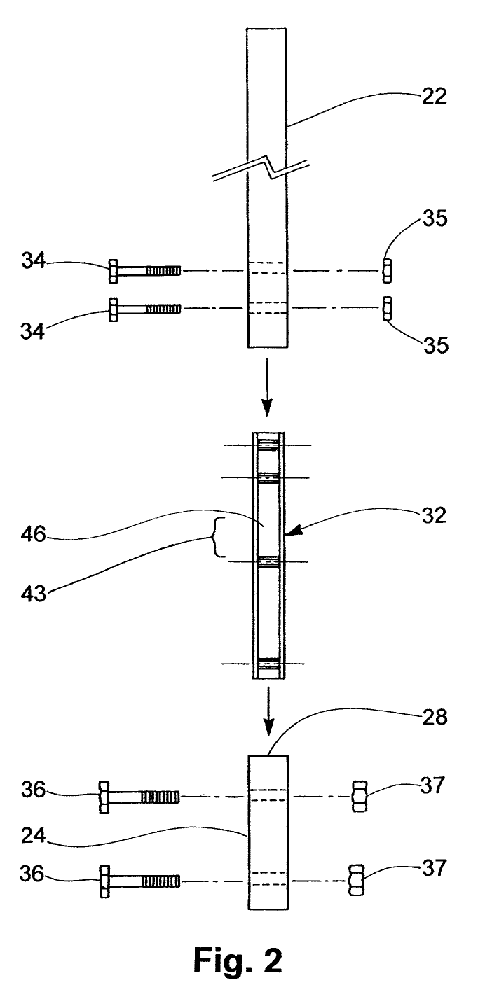

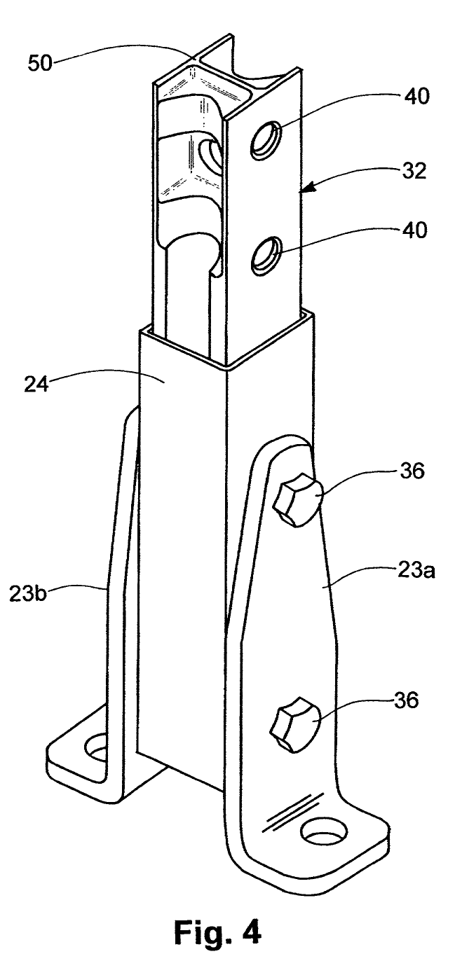

The sign assembly 10 has a large preferably flat panel or sign 18 made of either fabric or rigid material with a warning message or symbol on one side, and, when the sign 18 is fabric, braces (not shown) on another side. When the sign 18 is rigid, the sign 18 may be made out of metal or wood and may have attaching means (not shown) of some kind, as known in the art, to hold the sign 18 to the braces or directly to the sign mast 14. The sign mast 14 may have multiple parts including a first mast piece or pole 22, a second mast piece or receiver 24 and a breakaway member or breakaway beam 32. The breakaway beam 32 has a first end 50 that connects to the pole 22 which is secured to the sign 18. The breakaway beam 32 also has a second end 51 that connects to the receiver 24 which is connected to the base 20. As best shown in FIG. 4, brackets 23a, 23b attach the receiver 24 to the base 20. Each bracket 23a, 23b is preferably L-shaped and has bolt holes (not shown) for securing the bracket 23a or 23b to the base 20 and to the receiver 24 by conventional methods such as bolts and nuts, dow pins, rods with cotter pins, and the like, as is commonly known in industry. FIG. 2 shows an enlarged detail of how the breakaway beam 32 joins the pole 22 to the receiver 24 in combination with securement hardware 34, 35, 36, 37.

The term “beam” is used in a broad sense to represent any type of disposed structural member and does not specifically refer to an I-beam or necessarily to a horizontal structural member. Moreover, the term beam is used in a broad sense to encompass other types of structural members including, but not limited to: angles, channels, tubes, rods, bars, pipes, posts, flats, brackets, or other similar structural members or supports.

The pole 22 and receiver 24 can be of any conventional material that is strong enough to be used for the described purpose, although preferably it is of a hollow metal construction, such as aluminum or steel. At present, hollow tubes made from extruded aluminum material have provided satisfactory results. The cross-sectional shape of the pole 22 and receiver 24 is preferably square, although it is understood that the pole 22 and receiver 24 can have any cross-sectional size and shape so long as it can be used as a stand for a construction sign or similar display. The types of materials that are suitable for the pole 22 and receiver 24 in a given application depends upon such factors as the size, shape, and weight of the sign panel 18, the length and width of the base assembly 12, and other factors readily apparent to those skilled in the art.

Upon impact by a motor vehicle (not shown) the breakaway beam 32 is fractured through in the area proximate to where the post 22 and the receiver 24 are closest, thereby defining a breakaway section 43. This allows the portion of the sign assembly 10 connected to the pole 22 to be deflected away from the portion connected to the receiver 24 and thus, away from the motor vehicle (not shown). Preferably, the post 22 and the receiver 24 are separated by a predetermined distance (not shown) that is negligible. But, the post 22 and the receiver 24 may be separated by a predetermined distance from less than one inch to as great as sixty inches without departing from the scope of the invention.

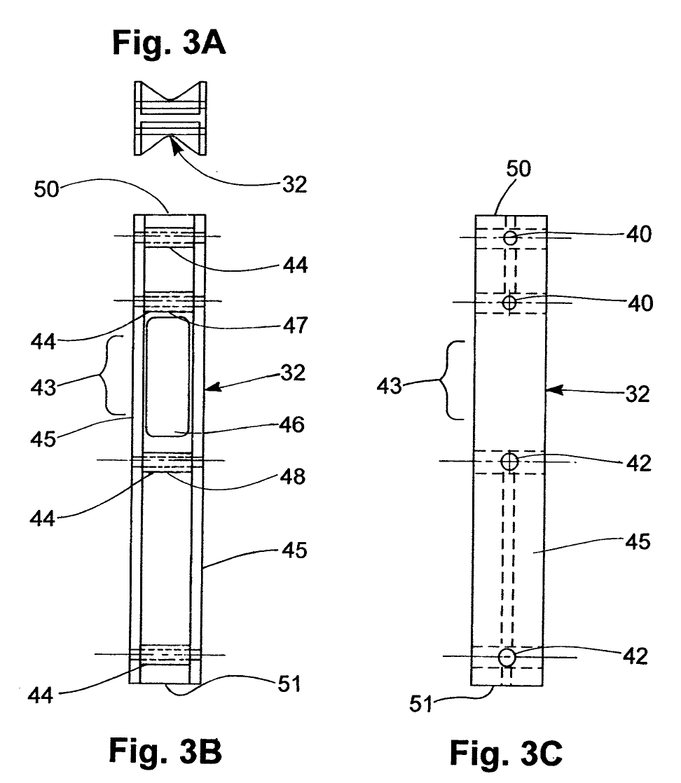

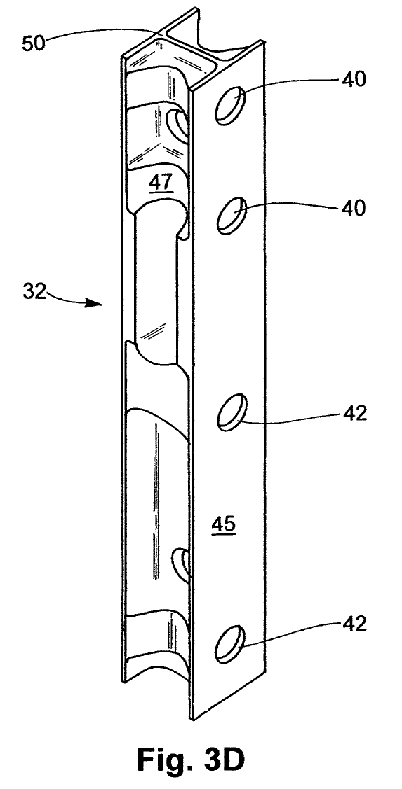

Referring to FIGS. 2-3C, the breakaway beam 32 is preferably an I-shape, although it is understood that breakaway beam 32 may be of an H-shape, a C-shape, a tube-shape, a flat-shape, a solid structure, or have any cross-sectional size and shape so long as it can be used to join the pole 22 to the receiver 24. Pole bolt holes 40 and receiver bolt holes 42 may extend partially into or completely through the breakaway beam 32 such that pole securing bolts 34 and receiver securing bolts 36 may secure the breakaway beam 32 to the pole 22 and the receiver 24, respectively. The pole bolts 34 may be threaded through the pole 22 into the breakaway beam 32 or alternatively mounted through the breakaway beam 32 and the pole 22 and secured with pole nuts 35. Likewise, receiver bolts 36 may be threaded through the receiver 24 and into the breakaway beam 32, or alternatively, mounted completely through the receiver 24 and the breakaway beam 32 and secured by receiver mounting nuts 37. The breakaway beam 32 is preferably secured to the pole 22 and receiver 24 with mating nuts 35, 37 and bolts 34, 36, although it is understood that any type of fastener or securement could be used such as pins, screws, nails, rivets, staples, dowels, epoxy, cement, snap grooves, key-ways, threaded fittings, couplings, spring tension devices, welds, or the like. In an alternate embodiment, the first and second ends 50, 51 of the breakaway beam 32 have a generally hollow cross section and the breakaway section 43 is substantially solid. Other variations and combinations of differing cross sections of the breakaway beam 32 may be used without departing from the spirit of the invention.

In the presently preferred embodiment, the breakaway beam 32 is formed or fashioned such that its outer dimensions are just slightly smaller than the inner dimensions of the pole 22 and the receiver 24. FIG. 2 shows that the second or bottom end 51 of the breakaway beam 32 is inserted into an opening 28 in the receiver 24 and secured with receiver bolts 36 and receiver nuts 37, the post 22 would then be slid on to the first or top end 50 of the breakaway beam 32 and secured with post bolts 34 and post nuts 35. It should be understood that the breakaway beam 32 could be formed as a bracket or socket instead and does not have to be completely concealed inside the mast 14.

The breakaway beam 32 may be formed of cast metal, extruded or molded plastic, fiberglass, wood, or other similar material that is capable of being broken clean through (fractured) upon impact, but the material must be strong enough to withstand normal static and wind loads without breaking or deforming. In the presently preferred embodiment, breakaway beam 32 is formed of cast metal of high hardness sufficient to break clean away upon impact.

FIG. 3A depicts an enlarged top view of breakaway beam 32 showing the preferred shape of the present invention. FIG. 3B shows an enlarged front view of the breakaway beam 32. The breakaway beam 32 is comprised of a pair of spaced, generally vertically extending, generally flat lateral beam members 45. A plurality of spaced, generally horizontal beam members 44 structurally reinforce the lateral beam members 45 along their length. The horizontal beam members 44 are preferably formed to coincide with the location of the bolt holes 40, 42, but there may be more or less beam members 44 than the number of bolt holes 40, 42. Preferably, the central portion of beam 32 has a hollow region 46 between lateral beam members 45 and a first horizontal member 47 and a second horizontal member 48. The hollow region 46 is preferably centered at the breakaway section 43 which is approximately the location where the pole 22 is closest to the receiver 24; thus, the structural integrity at this location in the breakaway beam 32 is weakest such that upon impact the pole 22 carries a portion (not shown) of the breakaway beam 32 clean from the receiver 24 by shear forces and another portion (not shown) of the breakaway beam 32 remains in the receiver 24. But, there need not be a hollow region 46 for the breakaway beam 32 to fracture clean through.

FIG. 4 shows the breakaway beam 32 installed in the receiver 24 portion of a mast 14. As shown, the mounting holes in the brackets 23a, 23b align with the receiver bolt holes 42 thereby allowing the receiver bolts 36 to secure the brackets 23a, 23b to the receiver 24 and the breakaway beam 32 within the receiver 24.

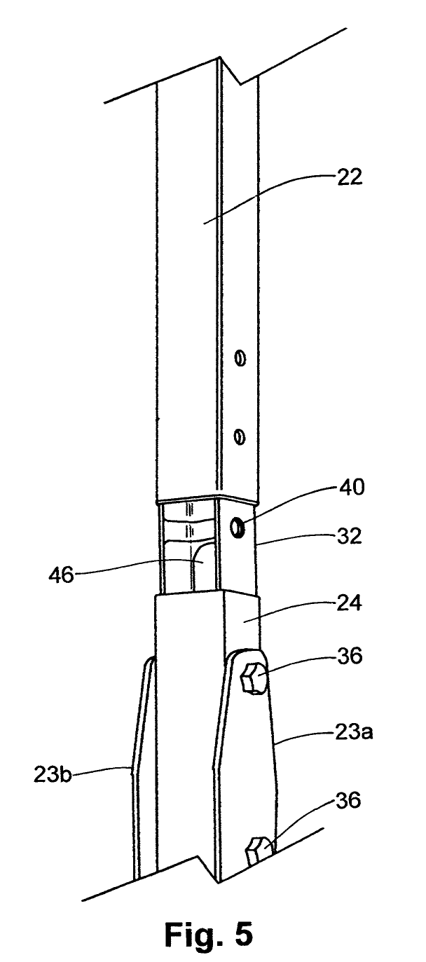

FIG. 5 shows the breakaway beam 32 as in FIG. 4 with the breakaway beam 32 in the receiver 24 of the mast 14 and with the pole 22 partially installed on the breakaway beam 32.

It will be appreciated that sign-stands of prior art designs can be retrofitted using the present invention by merely replacing the prior art mast (not shown) with the mast 14 including the breakaway beam 32 of the present invention.

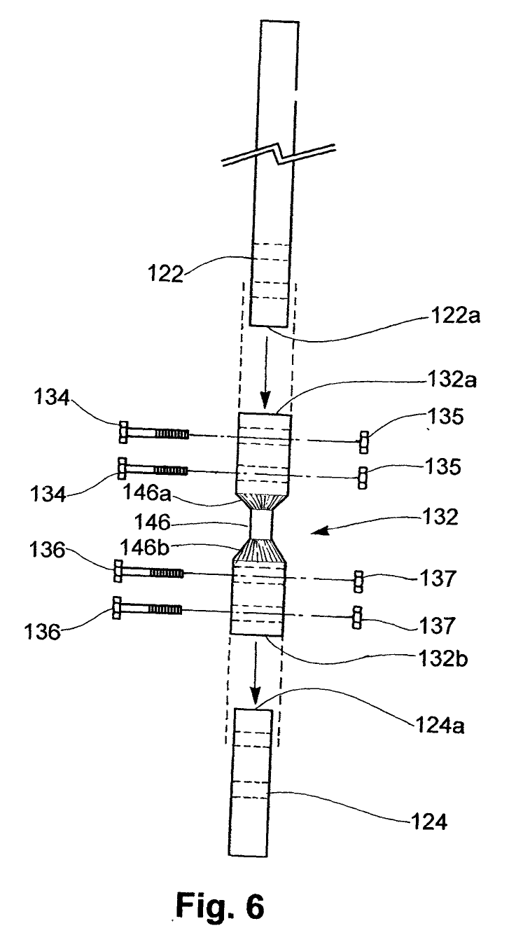

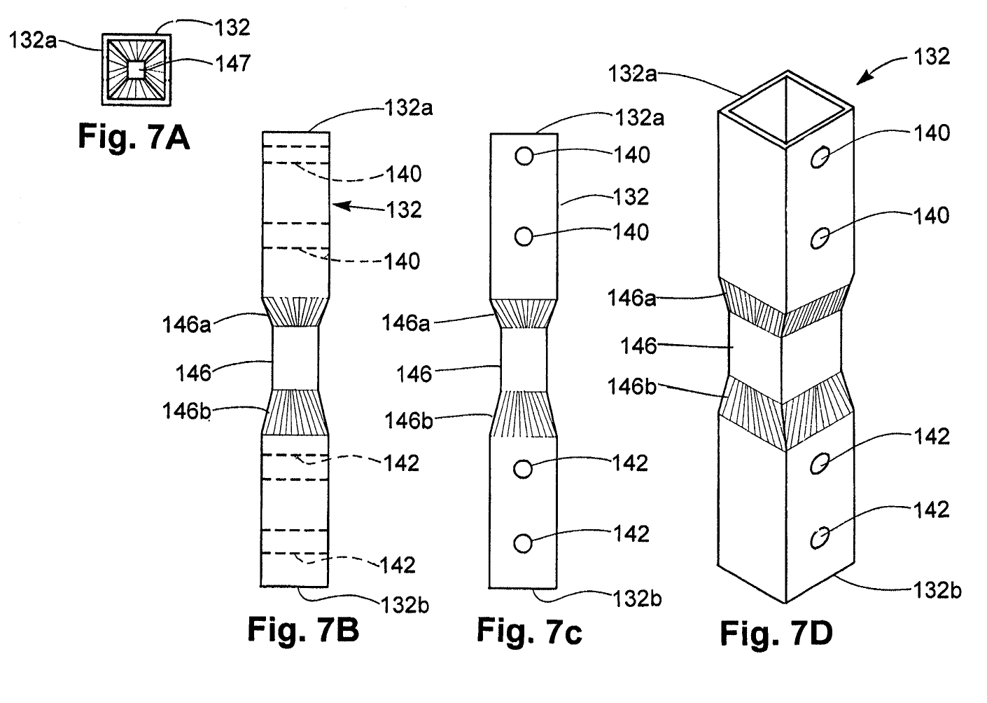

In a second preferred embodiment shown in FIGS. 6 and 7A-7D, the breakaway member is a breakaway coupling 132. The breakaway coupling 132 is used to join a pole 122 and a receiver 124. The breakaway coupling 132 has a first end 132a and a second end 132b. The breakaway coupling 132 has a geometric cross-sectional shape that is similar to that of the pole 122 and the receiver 124, but need not be.

The term “coupling” is used in a broad sense to represent any type of structural member that envelopes two other structures thereby joining them and does not specifically refer to a hollow or pipe coupling. Moreover, the term coupling is used in a broad sense to encompass other types of structural members including, but not necessarily limited to: cylinders, pipes, unions, adapters, slip fittings, bell and spigot fittings, couplers with square or rectangular cross-section, couplers with other geometric cross-sections, or other similar structural members for joining two pieces internally.

The breakaway coupling 132 may be a structure that is of uniform cross-section, but preferably has a square cross-section having a first tapered portion 146a to a reduced central section 146 and a second tapered portion 146b. The central section 146 may be solid or hollow, but the first end 132a and the second end 132b must be at least partially hollow in order to accommodate a bottom portion 122a of the pole 122 and a top portion 124a of the receiver 124, respectively. The first and second tapered portions 146a, 146b provide a shoulder to engage the pole 122 and the receiver 124 thereby aligning the pole 122, the receiver 124 and the central portion 146 properly. Alternatively, the central portion 146 could be of the same outer dimensions as the first and second ends 132a, 132b and an internal section 147 of the central portion 146 could be a flange or could be a solid plate to accomplish the alignment of the pole 122, the receiver 124 and the central portion 146. When the breakaway coupling 132 is completely hollow and of uniform cross-section, alignment of the breakaway coupling 132 with the pole 122 and the receiver 124 could be accomplished by the use of bolt holes, spring-loaded detents, tabs, or the like, but it should be noted that this is not critical to the invention.

Post bolt holes 140 and receiver bolt holes 142 may be formed partially into or completely through the breakaway coupling 132 such that post securing bolts 134 and receiver securing bolts 136 may secure the breakaway coupling 132 to the pole 122 and receiver 124, respectively. The pole bolts 134 may be threaded through the breakaway coupling 132 into the pole 122, or alternatively, mounted through the breakaway coupling 132 and the pole 122 and secured with pole nuts 135. Likewise, receiver bolts 136 may be threaded through the breakaway coupling 132 and into the receiver 124, or alternatively, mounted completely through the breakaway coupling 132 and the receiver 124 and secured by receiver mounting nuts 137. The breakaway coupling 132 is preferably secured to the post 122 and receiver 124 with mating nuts 135, 137 and bolts 134, 136, although it is understood that any type of fastener or securement could be used such as pins, screws, nails, rivets, staples, dowels, epoxy, cement, snap grooves, key-ways, threaded fittings, couplings, spring tension devices, welds, or the like.

Preferably, the breakaway coupling 132 is formed or fashioned such that its inner dimensions at the first and second ends 132a, 132b are just slightly larger than the outer dimensions of the bottom portion 122a of the pole 122 and the top portion 124a of the receiver 124. FIG. 6 shows that the second end 132b of the breakaway coupling 132 would be slid onto the top portion 124a of the receiver 124 and secured with receiver bolts 136 and receiver nuts 137, the bottom portion 122a of the post 122 would then be inserted into the first end 132a of the breakaway coupling 132 and secured with post bolts 134 and post nuts 135.

The breakaway coupling 132 may be formed of cast metal, extruded or molded plastic, fiberglass, wood, or other similar material that is capable of being broken clean through upon impact, but the material must be strong enough to withstand normal static and wind loads without breaking or deforming. Preferably, the breakaway coupling 132 is formed of cast metal of high hardness sufficient to break clean away by a low speed impact.

FIG. 7A depicts an enlarged top view of breakaway coupling 132 showing the preferred shape of the present embodiment. FIG. 7B shows an enlarged front view of the breakaway coupling 132. Preferably, the central portion of coupling 132 has a hollow, reduced-dimensioned central section 146 between the first end 132a and the second end 132b of the breakaway coupling 132. Thus, the structural integrity at the central section 146 of the breakaway coupling 132 is weakest such that upon impact the pole 122 carries a portion (not shown) of the breakaway coupling 132 clean from the receiver 124 and another portion (not shown) of the breakaway coupling 132 by shear forces. Thus, a portion of breakaway coupling 132 will remain on the receiver 124.

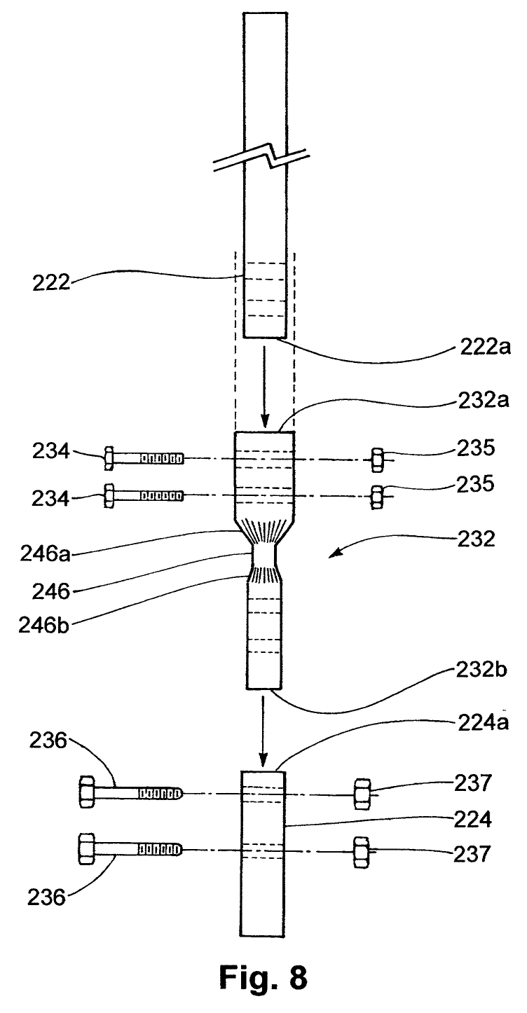

FIG. 8 shows a first alternate embodiment of the breakaway member in which the breakaway member 232 is a hybrid of a beam and a coupling. The breakaway member 232 is used to join a pole 222 and a receiver 224. The breakaway coupling 232 has a first end 232a and a second end 232b. Each end 232a, 232b of the breakaway coupling 232 has a geometric cross-sectional shape that is similar to that of the pole 222 and the receiver 224, respectively, but need not be. Preferably, the breakaway member 232 has a generally square cross-section has a first tapered portion 246a to a reduced central section 246 and a second tapered portion 246b. The central section 246 may be solid or hollow, but the first end 232a must be at least partially hollow in order to accommodate a bottom portion 222a of the pole 222. The second end 232b of the breakaway member 232 slides into a top portion 224a of the receiver 224. The first and second tapered portions 246a, 246b provide a shoulder to engage the bottom portion 222a of the pole 222 thereby aligning the pole 222 and the central portion 246 properly. Alternatively, the central portion 246 could be of the same outer dimension as the first end 232a and an internal section 247 of the central portion 246 could be a flange or could be a solid plate to accomplish the alignment of the pole 222 and the central portion 246. Post bolt holes (not shown clearly) and receiver bolt holes (not shown clearly) may be formed partially into or completely through the breakaway coupling 232 such that post securing bolts 234 and receiver securing bolts 236 secure the breakaway coupling 232 to the pole 222 and receiver 224, respectively. The pole bolts 234 may be threaded through the breakaway coupling 232 into the pole 222, or alternatively, mounted through the breakaway coupling 232 and the pole 222 and secured with pole nuts 235. Likewise, receiver bolts 236 may be threaded through the breakaway coupling 232 and into the receiver 224, or alternatively, mounted completely through the breakaway coupling 232 and the receiver 224 and secured by receiver mounting nuts 237. The breakaway coupling 232 is preferably secured to the post 222 and receiver 224 with mating nuts 235, 237 and bolts 234, 236, although it is understood that any type of fastener or securement could be used such as pins, screws, nails, rivets, staples, dowels, epoxy, cement, snap grooves, key-ways, threaded fittings, couplings, spring tension devices, welds, or the like.

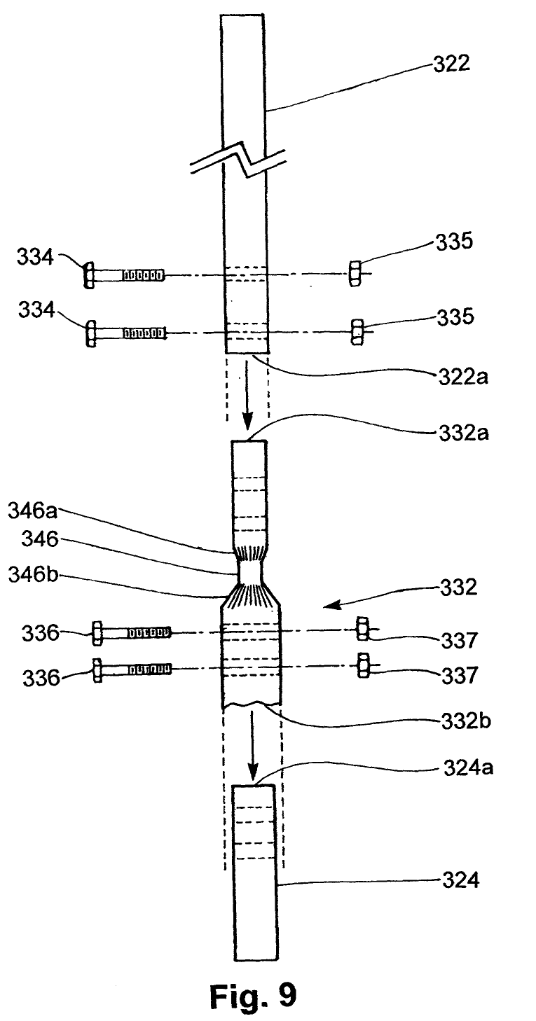

FIG. 9 shows a second alternate embodiment of the breakaway member similar to the first alternate embodiment, with a coupling portion and a beam portion reversed from the first alternate embodiment. A breakaway member 332 is used to join a pole 322 and a receiver 324. The breakaway coupling 332 has a first end 332a and a second end 332b. Each end 332a and 332b of the breakaway coupling 332 has a geometric cross-sectional shape that is similar to that of the pole 322 and the receiver 324, respectively, but need not be. Preferably, the breakaway coupling 332 has a square cross-section and has a first tapered portion 346a to a reduced central section 346 and a second tapered portion 346b. The central section 346 may be solid or hollow, but the second end 332b must be at least partially hollow in order to accommodate a top portion 324a of the receiver 324, respectively. A bottom portion 322a of the pole 322 slides onto the first end 332a of the breakaway member 332. The first and second tapered portions 346a, 346b provide a shoulder to engage the top portion 324a of the receiver 324 thereby aligning the receiver 324 and the central portion 346 properly. Alternatively, the central portion 346 could be of the same outer dimensions as the second end 332b and an internal section 347 of the central portion 346 could be a flange or could be a solid plate to accomplish the alignment of the receiver 324 and the central portion 346. Post bolt holes (not shown clearly) and receiver bolt holes (not shown clearly) may be formed partially into or completely through the breakaway coupling 332 such that post securing bolts 334 and receiver securing bolts 336 may secure the breakaway coupling 332 to the pole 322 and receiver 324, respectively. The pole bolts 334 may be threaded through the breakaway coupling 332 into the pole 322, or alternatively, mounted through the breakaway coupling 332 and the pole 322 and secured with pole nuts 335. Likewise, receiver bolts 336 may be threaded through the breakaway coupling 332 and into the receiver 324, or alternatively, mounted completely through the breakaway coupling 332 and the receiver 324 and secured by receiver mounting nuts 337. The breakaway coupling 332 is preferably secured to the post 322 and receiver 324 with mating nuts 335, 337 and bolts 334, 336, although it is understood that any type of fastener or securement could be used such as pins, screws, nails, rivets, staples, dowels, epoxy, cement, snap grooves, key-ways, threaded fittings, couplings, spring tension devices, welds, or the like.

From the foregoing, it can be seen that the present invention comprises a breakaway sign-stand which breaks cleanly away during impact. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A breakaway member for a sign-stand having a two piece mast that supports a sign, the breakaway member comprising:
(a) a first end that connects to a first mast piece which is secured to the sign;
(b) a second end that connects to a second mast piece; and
(c) a breakaway section that fractures therethrough upon impact thereby separating the first end, the first mast piece and the sign from the second mast piece.

2. The breakaway member according to claim 1, wherein the breakaway member comprises a coupling having a generally rectangular and hollow cross-section, the first and second mast pieces have a generally rectangular and hollow cross-section, a first end of the first mast piece is disposed in the first end of the breakaway member, a first end of the second mast piece is disposed in the second end of the breakaway member, and the breakaway section is located between the first and second mast pieces.

3. The breakaway member according to claim 2, wherein the first and second mast pieces are separated by a predetermined distance.

4. The breakaway member according to claim 2, wherein the first and second ends of the breakaway member have a generally hollow cross section and the breakaway section is substantially solid

5. The breakaway member according to claim 1, wherein the breakaway member comprises a generally I-beam shaped cross section and the first and second mast pieces have a generally rectangular and hollow cross-section, the first end of the breakaway member being disposed in the first mast piece, the second end of the breakaway member is disposed in the second mast piece, and the breakaway section is located between the first and second mast pieces.

6. The breakaway member according to claim 5, wherein a first end of the first mast piece is substantially adjacent to a first end of the second mast piece and the region between the first and second mast pieces is negligible.

7. The breakaway member according to claim 1, wherein the breakaway member is formed of metal.

8. The breakaway member according to claim 7, wherein the metal is formed by casting.

9. The breakaway member according to claim 1, wherein the breakaway member is formed of fiberglass.

10. The breakaway member according to claim 1, wherein the breakaway section has a smaller cross sectional area than the cross sectional area of the first end of the breakaway member.

11. The breakaway member according to claim 1, wherein the breakaway member comprises a generally rectangular beam of uniform cross-section, the first and second mast pieces have a generally rectangular and hollow cross-section, the first end of the breakaway member is disposed in the first mast piece, the second end of the breakaway member is disposed in the second mast piece, and the breakaway section is located between the first and second mast pieces.

12. The breakaway member according to claim 1, wherein the breakaway member comprises a generally cylindrical beam, the first and second mast pieces have a generally circular and hollow cross-section, the first end of the breakaway member is disposed in the first mast piece, the second end of the breakaway member is disposed in the second mast piece, and the breakaway section is located between the first and second mast pieces.

13. The breakaway member according to claim 1, wherein the breakaway member comprises a coupling having a generally rectangular and hollow cross-section, the first and second mast pieces have a generally rectangular cross-section, a first end of the first mast piece is disposed in the first end of the breakaway member, a first end of the second mast piece is disposed in the second end of the breakaway member, and the breakaway section is located between the first and second mast pieces.
